(19) United States
(12) Patent Application Publication
(10) Pub. No.: US 2021/0354702 A1
(43) Pub. Date: Nov. 18, 2021

(54) AGENT CONTROL DEVICE, AGENT CONTROL METHOD, AND RECORDING MEDIUM

(71) Applicant: TOYOTA JIDOSHA KABUSHIKI KAISHA, Toyota-shi (JP)

(72) Inventor: Kohki TAKESHITA, Tokyo (JP)

(73) Assignee: TOYOTA JIDOSHA KABUSHIKI KAISHA, Toyota-shi (JP)

(21) Appl. No.: 17/243,104

(22) Filed: Apr. 28, 2021

(30) Foreign Application Priority Data
May 18, 2020 (JP) 2020-086646

(51) Int. Cl. B60W 40/08; G06F 16/9035

(52) U.S. Cl. CPC B60W 40/08; G06F 16/9035; B60W 2040/0809; B60W 2540/043; B60W 2540/21

(57) ABSTRACT

An agent control device that acquires agent utilization history information for a user, selects one agent from among a plurality of agents that are utilizable inside a vehicle based on the acquired utilization history information, and activates the selected agent.

### CROSS-REFERENCE TO RELATED APPLICATION

This application is based on and claims priority under 35 USC 119 from Japanese Patent Application No. 2020-086646 filed on May 18, 2020, the disclosure of which is incorporated by reference herein.

### BACKGROUND

### Technical Field

The present disclosure relates to an agent control device, an agent control method, and a recording medium.

### Related Art

Japanese Patent Application Laid-Open (JP-A) No. 2018-189984 discloses a speech interaction method for utilizing services provided by two agents in which agent information such as a keyword used to identify an agent is employed to decide which out of the two agents should respond.

In the technology disclosed in JP-A No. 2018-189984, the agent to respond is decided based on a keyword or the like identifying the agent. However, in the technology disclosed in JP-A No. 2018-189984, the user needs to utter the keyword or the like in order to identify the agent, and so there is room for improvement regarding smoother selection of an agent.

For example, plural utilizable agents may be available inside a vehicle. However, the technology disclosed in JP-A No. 2018-189984 only discloses selection of a target agent based on a keyword identifying the agent, and does not consider situations in which plural utilizable agents are available inside the vehicle.

Thus, with the technology disclosed in JP-A No. 2018-189984 an issue may arise in which agent selection cannot be smoothly performed during user selection of a utilizable agent when on board a vehicle.

### SUMMARY

An aspect of the disclosure is an agent control device that includes: a memory; and a processor coupled to the memory. The processor is configured to: acquire agent utilization history information for a user, select one agent from among a plurality of agents that are utilizable inside a vehicle based on the acquired utilization history information, and activate the selected agent.

### BRIEF DESCRIPTION OF THE DRAWINGS

Exemplary embodiments of the present disclosure will be described in detail based on the following figures, wherein:

FIG. 1 is an explanatory diagram to provide schematic explanation of an exemplary embodiment;

FIG. 2 is a schematic block diagram illustrating an example of an agent control system according to an exemplary embodiment;

FIG. 3 is a diagram illustrating an example of configuration of a computer of an agent control device;

FIG. 4 is a diagram illustrating an example of identification information of plural agents;

FIG. 5 is a diagram illustrating an example of utilization history information;

FIG. 6 is a flowchart illustrating an example of processing performed by an agent control device according to an exemplary embodiment; and

FIG. 7 is a flowchart illustrating an example of processing performed by an agent control device according to an exemplary embodiment.

### DETAILED DESCRIPTION

### Exemplary Embodiment

Explanation follows regarding an agent control system of an exemplary embodiment, with reference to the drawings.

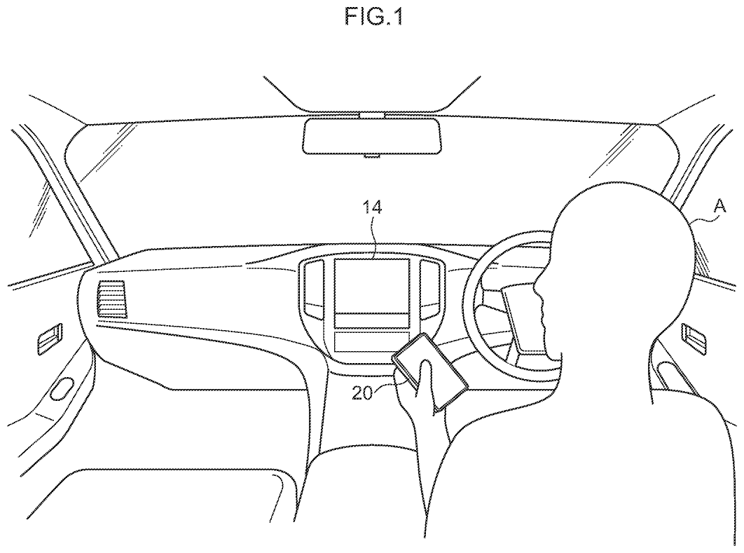

FIG. 1 is an explanatory diagram to provide schematic explanation of the present exemplary embodiment. FIG. 1 is a diagram illustrating a situation in which a user A is on board a vehicle. The user A possesses a mobile terminal 20 such as a smartphone. FIG. 1 also illustrates a touch panel 14, this being an example of a display unit that displays various information, located inside the vehicle. The touch panel 14 and the mobile terminal 20 are connected to an agent control device, described later.

In cases in which plural utilizable agents are available inside the vehicle, the user A may wish to operate an agent that they wish to utilize inside the vehicle.

An agent of the present exemplary embodiment performs speech interaction with the user A, and executes processing that reflects the content of this interaction. The agent then uses equipment inside the vehicle to output an execution result of this processing so as to reflect the interaction content. The agents of the present exemplary embodiment are implemented by agent servers, described later, executing predetermined programs.

For example, the user A may wish to utilize an agent that they regularly utilize on their mobile terminal 20 when inside the vehicle. Alternatively, the user A may wish to utilize an agent that they use at home when inside the vehicle. Alternatively, the user A may wish to utilize an agent that can only be utilized inside the vehicle when inside the vehicle.

In cases in which plural utilizable agents are available inside the vehicle, the agent control device of the present exemplary embodiment selects one agent from out of the plural agents based on an agent utilization history for the user. In cases in which plural utilizable agents are available inside the vehicle, the agent control device selects an agent to be utilized by the user A, thereby enabling agent selection to be smoothly performed.

Detailed explanation thereof follows below.

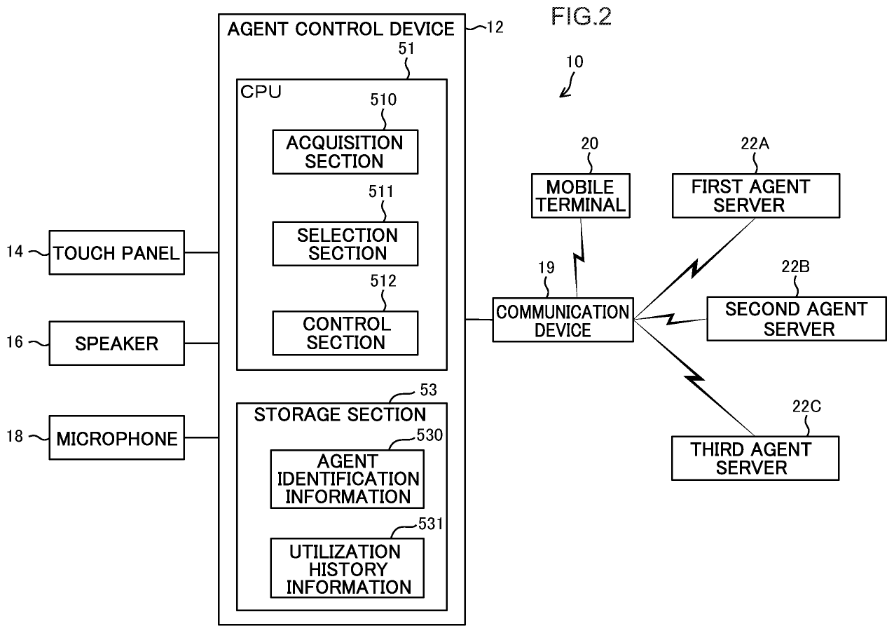

FIG. 2 is a block diagram illustrating an example of configuration of an agent control system 10 according to the exemplary embodiment. As illustrated in FIG. 2, the agent control system 10 includes an agent control device 12, the touch panel 14, a speaker 16, a microphone 18, a communication device 19, the mobile terminal 20, a first agent server 22A, a second agent server 22B, and a third agent server 22C. The agent control device 12, the touch panel 14, the speaker 16, the microphone 18, and the communication device 19 are all installed in a single vehicle.

Agent Control Device

As illustrated in FIG. 2, the agent control device 12 includes a central processing unit (CPU) 51 and a storage section 53.

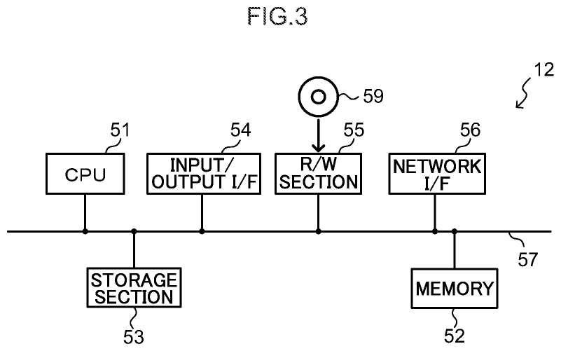

More specifically, the agent control device 12 may for example be implemented by a computer such as that illustrated in FIG. 3. The computer that implements the agent control device 12 includes the CPU 51, this being an example of a hardware processor, memory 52 serving as a temporary storage region, and the non-volatile storage section 53. The computer also includes an input/output interface (I/F) 54 to which an input/output device and so on are connected, and a read/write (R/W) section 55 that controls reading and writing of data on a recording medium 59. The computer also includes a network I/F 56 that is connected to a network such as the internet. The CPU 51, the memory 52, the storage section 53, the input/output I/F 54, the R/W section 55, and the network I/F 56 are connected to each other through a bus 57.

The storage section 53 may be implemented by a hard disk drive (HDD), a solid state drive (SSD), flash memory, or the like, these being examples of a non-transitory recording medium. The storage section 53 serves as a storage medium stored with a program causing the computer to implement functionality. The CPU 51 reads the program from the storage section 53, expands the program in the memory 52, and sequentially executes processes included in the program. The program may for example be recorded on a non-transitory recording medium such as a digital versatile disc (DVD), and read into the HDD, SSD, or the like from this non-transitory recording medium using a recording medium reader device.

As illustrated in FIG. 2, the CPU 51 of the agent control device 12 loads the program from the storage section 53 and executes the program using the memory 52 as a workspace in order to function as an acquisition section 510, a selection section 511, and a control section 512. Processing performed by the acquisition section 510, the selection section 511, and the control section 512 is described later.

As is also illustrated in FIG. 2, agent identification information 530 and utilization history information 531 are stored in the storage section 53 of the agent control device 12.

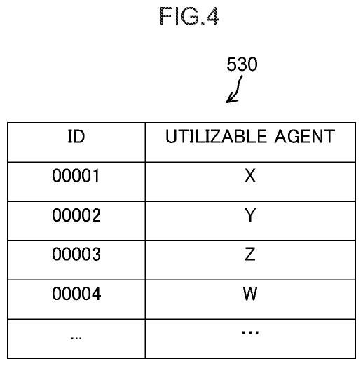

FIG. 4 is a diagram illustrating an example of the agent identification information 530 stored in the storage section 53. FIG. 4 illustrates an example of identification information for an agent X operated by the first agent server 22A, an agent Y operated by the second agent server 22B, an agent Z operated by the third agent server 22C, and an agent W operated by the mobile terminal 20. Note that the agent identification information 530 may be acquired by the acquisition section 510 and retained by the storage section 53 whenever agent activation processing, described later, is executed.

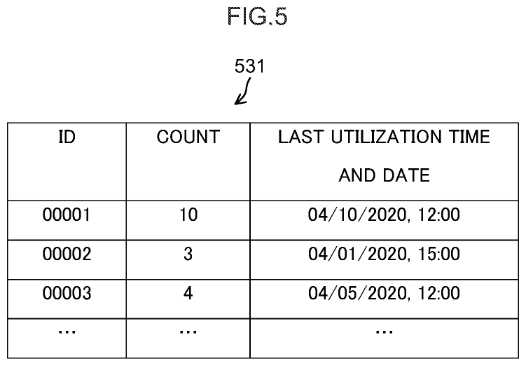

FIG. 5 is a diagram illustrating an example of the utilization history information 531 stored in the storage section 53. FIG. 5 illustrates both an agent utilization count and a last agent utilization time and date as the utilization history information 531 for agents that have been utilized inside the vehicle. The agent utilization count may be a utilization count covering the entire period since when the agent control device 12 was first activated, or may be a utilization count covering a predetermined recent period (such as the last month). The utilization history information 531 may be generated by tallying based on an agent utilization log.

The touch panel 14 is connected to the agent control device 12 through the input/output I/F 54. The touch panel 14 displays images as appropriate. The touch panel 14 also receives operation information from a user.

The speaker 16 is connected to the agent control device 12 through the input/output I/F 54, and outputs audio.

The microphone 18 is connected to the agent control device 12 through the input/output I/F 54, and picks up speech uttered inside the vehicle.

The communication device 19 is connected to the agent control device 12 through the network I/F 56. The agent control device 12 exchanges information with the first agent server 22A, the second agent server 22B, and the third agent server 22C via the communication device 19. Note that the communication device 19 and the first agent server 22A, the second agent server 22B, and the third agent server 22C may for example be connected together over a communication line such as the internet.

Similarly, the agent control device 12 and the mobile terminal 20 exchange information via the communication device 19. The agent control device 12 and the mobile terminal 20 are for example connected together using a predetermined short range communication protocol.

Agent Servers

As illustrated in FIG. 2, the agent control system 10 of the present exemplary embodiment includes the first agent server 22A, the second agent server 22B, and the third agent server 22C.

The first agent server 22A, the second agent server 22B, and the third agent server 22C are all servers that operate agents. The respective agents are implemented by the first agent server 22A, the second agent server 22B, and the third agent server 22C each executing a predetermined program. In the present exemplary embodiment, the agent X is operated by the first agent server 22A, the agent Y is operated by the second agent server 22B, and the agent Z is operated by the third agent server 22C.

Mobile Terminal

The mobile terminal 20 is for example a smartphone in the possession of and regularly used by a user inside the vehicle. The user on board the vehicle is able to utilize an agent operated by the mobile terminal 20. Note that the agent W is operated by the mobile terminal 20 in the present exemplary embodiment.

Next, explanation follows regarding operation of the agent control system 10 of the exemplary embodiment.

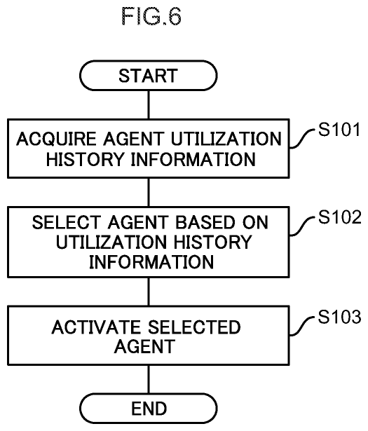

FIG. 6 is a flowchart illustrating an example of the agent activation processing performed by the agent control device 12.

The acquisition section 510 consults the agent utilization history information 531 stored in the storage section 53, and acquires the agent utilization history information 531 (step S101).

Following step S101, the selection section 511 selects one agent from out of the plural utilizable agents available inside the vehicle based on the utilization history information 531 acquired by the acquisition section 510 (step S102). For example, the selection section 511 selects the agent that has the highest utilization count based on the utilization history information 531. In cases in which plural agents share the same highest utilization count, the selection section 511 may select the most recently utilized agent, namely the agent with the most recent last utilization time and date, or may select a preset specific agent.

Following step S102, the control section 512 activates the agent selected by the selection section 511 (step S103).

Thus, in cases in which plural utilizable agents are available inside the vehicle, the agent control device 12 is able to select and activate the agent that has the highest utilization count based on the utilization history information 531.

Note that cases may conceivably arise in which the agent with the highest utilization count cannot be utilized for some reason. Explanation follows regarding an example of agent activation processing by the agent control device 12 in a case in which the agent with the highest utilization count cannot be utilized.

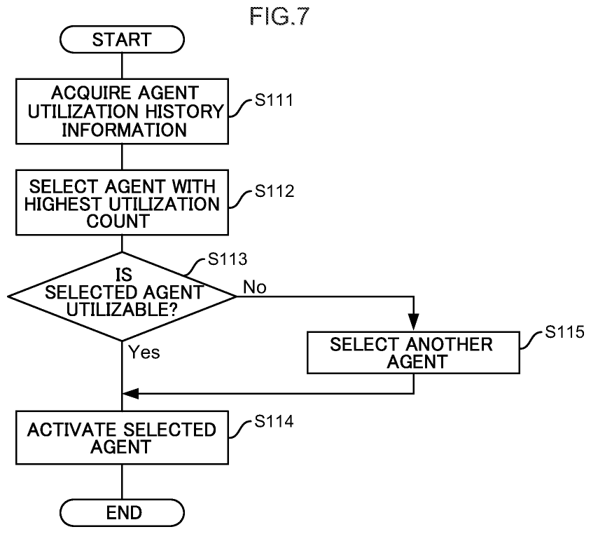

FIG. 7 is a flowchart illustrating a different example of agent activation processing by the agent control device 12.

The acquisition section 510 consults the agent utilization history information 531 for the user A stored in the storage section 53, and acquires the agent utilization history information 531 (step S111).

Following step S111, the selection section 511 selects the agent with the highest utilization count from out of the plural utilizable agents available inside the vehicle based on the utilization history information 531 acquired by the acquisition section 510 (step S112). In cases in which there plural agents share the same highest utilization count, the selection section 511 may select the most recently utilized agent, namely the agent with the most recent last utilization time and date, or may select a preset specific agent.

Following step S112, the control section 512 determines whether or not the agent selected by the selection section 511 is utilizable (step S113). An example of a case in which the agent with the highest utilization frequency by the user is not utilizable is a case in which it is not possible to communicate with the agent server of this agent.

In cases in which the determination result at step S113 is that the agent selected by the selection section 511 is utilizable (step S113: Yes), the control section 512 activates the agent selected by the selection section 511 at step S112 (step S114).

In cases in which the determination result at step S113 is that the agent selected by the selection section 511 is not utilizable (step S113: No), the control section 512 causes the selection section 511 to select a different agent. The selection section 511 then selects another agent that is utilizable inside the vehicle and is different from the agent selected at step S112 (step S115). For example, the selection section 511 may select a preset specific agent from out of the plural agents. Alternatively, the selection section 511 may for example select the agent with the second highest utilization count. Following step S115, the control section 512 activates the agent selected by the selection section 511 at step S115 (step S114).

As described above, in cases in which plural utilizable agents are available inside the vehicle, the agent control device 12 of the exemplary embodiment selects one agent based on the utilization history for the user. This enables the user A to use an agent selected by the agent control device 12 inside the vehicle in cases in which plural utilizable agents are available inside the vehicle.

Although explanation has been given in which the processing performed by the respective devices is software processing performed by executing a program in the exemplary embodiment described above, the processing may be performed by hardware. Alternatively, the processing may be performed by a combination of both software and hardware. Moreover, a program stored in ROM may be distributed in a format stored on a non-transitory recording medium.

The present disclosure is not limited to the above description, and various other modifications may be implemented within a range not departing from the spirit of the present disclosure.

For example in cases in which sufficient agent utilization history information has not yet been accumulated, for example when an agent is used for the first time (for example when a combined utilization count of agents inside the vehicle is a predetermined threshold value or below), the selection section 511 of the CPU 51 may select a preset specific agent from out of the plural agents. Then, once sufficient utilization history information has been accumulated (for example when the combined utilization count of agents inside the vehicle exceeds the predetermined threshold value), the selection section 511 may select the agent with the highest utilization frequency. This enables the agent control device 12 to activate a designated agent according to initial settings on first use, and then to prioritize activation of another agent if the user utilizes this other agent frequently.

An object of the present disclosure is to provide an agent control device, an agent control method, and a non-transitory recording medium capable of offering an improved agent selection experience when a user selects an agent from out of plural utilizable agents when on board a vehicle.

A first aspect of the disclosure is an agent control device that includes: a memory; and a processor coupled to the memory. The processor is configured to acquire agent utilization history information for a user, select one agent from among a plurality of agents that are utilizable inside a vehicle based on the acquired utilization history information, and activate the selected agent.

The agent control device acquires the agent utilization history information for the user. Note that the agent of the present aspect performs speech interaction with the user, and executes processing that reflects the content of this interaction. The agent then uses equipment inside the vehicle to output an execution result of this processing so as to reflect the interaction content. The agent is implemented by a predetermined computer executing a program. The agent control device selects one agent from among the plural agents that are utilizable inside the vehicle based on the acquired utilization history information. The agent control device then performs activate the selected agent. The agent control device of the first aspect is capable of performing agent selection smoothly when selecting a utilizable agent when the user is on board the vehicle by consulting the utilization history.

A second aspect of the disclosure is the agent control device of the first aspect, wherein the processor is configured to select an agent with a highest user utilization frequency based on the utilization history information. The agent control device of the second aspect selects the agent with the highest utilization frequency during selection of a utilizable agent when the user is on board the vehicle, thereby enabling agent selection to be performed smoothly.

A third aspect of the disclosure is the agent control device of the first aspect, wherein the processor is configured to select another agent that is utilizable inside the vehicle in a case in which an agent with a highest user utilization frequency is not utilizable. The agent control device of the third aspect enables another agent to be selected in a case in which the agent with the highest utilization frequency by the user is not utilizable when selecting a utilizable agent when the user is on board the vehicle.

A fourth aspect of the disclosure is the agent control device of the third aspect, wherein the processor is configured to select a preset specific agent. The agent control device of the fourth aspect selects the preset specific agent during selection of a utilizable agent when the user is on board the vehicle, thereby enabling agent selection to be performed smoothly.

A fifth aspect of the disclosure is the agent control device of the third aspect, wherein the processor is configured to select an agent with a second highest utilization frequency. The agent control device of the fifth aspect selects the agent with the second highest utilization frequency during selection of a utilizable agent when the user is on board the vehicle, thereby enabling agent selection to be performed smoothly.

A sixth aspect of the disclosure is the agent control device of the first aspect, wherein the processor is configured to select a preset specific agent from among the plurality of agents in a case in which a combined agent utilization count is a predetermined threshold value or below. The agent control device of the sixth aspect is capable of activating an agent designated in initial settings on first use, and then prioritizing activation of another agent if the user utilizes this other agent frequently.

The first aspect to the sixth aspect may be implemented by a method or by a program recorded on a non-transitory recording medium.

The present disclosure is capable of providing an agent control device, an agent control method, and a non-transitory recording medium capable of offering an improved agent selection experience when a user selects one agent from among plural agents based on an agent utilization history of the user.

What is claimed is:

1. An agent control device comprising:
a memory; and
a processor coupled to the memory, the processor being configured to acquire agent utilization history information for a user,
select one agent from among a plurality of agents that are utilizable inside a vehicle based on the acquired utilization history information, and
activate the selected agent.

2. The agent control device of claim 1, wherein the processor is configured to select an agent with a highest user utilization frequency based on the utilization history information.

3. The agent control device of claim 1, wherein the processor is configured to select another agent that is utilizable inside the vehicle in a case in which an agent with a highest user utilization frequency is not utilizable.

4. The agent control device of claim 3, wherein the processor is configured to select a preset specific agent.

5. The agent control device of claim 3, wherein the processor is configured to select an agent with a second highest utilization frequency.

6. The agent control device of claim 1, wherein the processor is configured to select a preset specific agent from among the plurality of agents in a case in which a combined agent utilization count is a predetermined threshold value or below.

7. An agent control method, comprising, by a processor:
acquiring agent utilization history information for a user;
selecting one agent from among a plurality of agents that are utilizable inside a vehicle based on the acquired utilization history information; and
activating the selected agent.

8. The agent control method of claim 7, wherein an agent with a highest user utilization frequency is selected based on the utilization history information.

9. The agent control method of claim 7, wherein another agent that is utilizable inside the vehicle is selected in a case in which an agent with a highest user utilization frequency is not utilizable.

10. The agent control method of claim 9, wherein a preset specific agent is selected.

11. The agent control method of claim 9, wherein an agent with a second highest utilization frequency is selected.

12. The agent control method of claim 7, wherein a preset specific agent is selected from among the plurality of agents in a case in which a combined agent utilization count is a predetermined threshold value or below.

13. A non-transitory recording medium storing a program that is executable by a computer to perform processing, the processing comprising:
acquiring agent utilization history information for a user;
selecting one agent from among a plurality of agents that are utilizable inside a vehicle based on the acquired utilization history information; and
activating the selected agent.

14. The non-transitory recording medium of claim 13, wherein an agent with a highest user utilization frequency is selected based on the utilization history information.

15. The non-transitory recording medium of claim 13, wherein another agent that is utilizable inside the vehicle is selected in a case in which an agent with a highest user utilization frequency is not utilizable.

16. The non-transitory recording medium of claim 15, wherein a preset specific agent is selected.

17. The non-transitory recording medium of claim 15, wherein an agent with a second highest utilization frequency is selected.

18. The non-transitory recording medium of claim 13, wherein a preset specific agent is selected from among the plurality of agents in a case in which a combined agent utilization count is a predetermined threshold value or below.
